(19) United States
(12) Patent Application Publication
(10) Pub. No.: US 2017/0044809 A1
(43) Pub. Date: Feb. 16, 2017

(54) Locking Device

(71) Applicant: ARS MECCANICA DOLOMITI GMBH, Bozen (IT)

(72) Inventor: Aldo Chisté, Eppan (IT)

(21) Appl. No.: 15/039,280

(22) PCT Filed: Nov. 29, 2013
(86) PCT No.: PCT/EP2013/075097

§ 371 Date: Nov. 4, 2016

(51) Int. Cl. E05D 7/10; F16G 3/00

(52) U.S. Cl. CPC E05D 7/10; F16G 3/00

(57) ABSTRACT

A closure device is disclosed. In embodiments, the device includes a closing rod, a first closing body, wherein the first closing body includes at least one first feedthrough for the closing rod, at least one engaging element and a second closing body, wherein the second closing body includes at least one open feedthrough for the at least one engaging element. The closing rod is configured to be rotatably located in the at least one feedthrough and the at least one engaging element, and wherein the first closing body and the second closing body are repeatedly connectable and disconnectable.

### CROSS-REFERENCE TO RELATED APPLICATIONS

This patent application is a national phase filing under section 371 of PCT/EP2013/075097, filed Nov. 29, 2013, which is incorporated herein by reference in its entirety.

### TECHNICAL FIELD

The embodiments of the present invention relate to a closure device between two ends to be connected of two or more parts. The embodiments relate, in particular, to a closure device for the detachable connection of two closing bodies that make up parts of the closure device.

### BACKGROUND

The connection of objects to each other via straps, belts, ropes, lines, etc. typically requires the connection of at least two ends to each other via a clasp or a knot or any other common method. This is also true for the connection of objects such as door leaves to a doorframe via a hinge. This process often requires time to ensure safety for both workers and the product, especially during disassembly. Lifting straps should rest across the entire width of an object to ensure maximum lifting capacity. Devices known in the art have not yet been able to effectively meet this requirement.

EP 0 738 840 A2 describes a belt connector with connecting clips and a coupling rod which is passed through the joints of the hinge bows, which fit into one another, of the connecting clips. The coupling rod and the connecting clips consist of austenitic manganese steel. A common coupling rod is passed through the joints of the hinge bows, which fit into one another, and two belt connectors at the full cross-section. The clip limbs of the connecting clips have openings for passage of the fastening staples.

Connections should form a secure fastening, while allowing for easy assembly and disassembly. Especially with lifting straps, it is preferable to eliminate the compression of springs or the necessity of lifting and twisting straps.

An improved closure device should be provided.

### SUMMARY

Embodiments of the invention provide a reduction in time for closing and opening the two connector ends of two elements (e.g., of belts, straps, ropes, strings, or objects to be connected together so they can rotate) and still achieve increased safety and reliability.

In one embodiment, a closure device for repeated connection and disconnection of a first closing body with a second closing body is introduced. The closure device also contains a closing rod wherein the first closing body contains at least one feedthrough for the closing rod wherein the closing rod is rotatable in at least one feedthrough and the second closing body consists of at least one engaging element that can be locked with the closing rod by rotating the closing rod. This rotatable locking mechanism of a connection of closing bodies by rotating a closing rod makes it easy to position the closing bodies for locking. This facilitates the connection and disconnection, as well as the closing and opening, of the closure device.

In another advantageous embodiment, the closing rod can be translationally fed in a first rotational position of the closing rod into the second closing body in a radial direction of the closing rod and can be radially fixated in the second closing body in a second rotational position that differs from the first rotational position. The translational movement when joining the closing bodies makes it particularly easy to position them into a closing position that can be locked by turning the closing rod. Because the rotation of locking is independent of the direction of the load of the closure device, increased locking safety can be guaranteed.

In yet another advantageous embodiment, the at least one engaging element can be mounted in a rotatable manner in the second closing body. In particular, in yet another advantageous embodiment, the at least one engaging element can be formed in such a way that it can laterally compass the closing rod in a first sector and is rotated by turning the closing rod in the second closing body. In yet another advantageous embodiment, the at least one engaging element can be a cylindrical body (e.g., a sleeve) that features a cavity with which it can laterally compass the closing rod. The use of a sleeve can improve resilience and can also be used to achieve higher load capacity and/or higher tensile force because the components of the closure device can be positively provided.

In yet another advantageous embodiment, the closing rod can contain at least a first portion and at least a second portion, wherein the second portion has a round cross section and the first portion has dimensions in all directions that are less than the round cross section of the second portion. This allows the use of a sleeve. The dimensions in these directions can be understood as maximum lengths of the limits of the cross section in each spatial direction. In at least one spatial direction, the first portion can have a range that remains unchanged compared to the second portion; that is to say, material was not removed from a round rod. Because the material thickness in the opposite spatial direction is less than the round cross section, the dimension of the cross section in this spatial direction changes. This corresponds to the fact that the sleeve encircles the first portion by more than 180°.

In yet another advantageous embodiment, the closing rod can contain at least a first portion and at least a second portion, wherein the second portion has a round cross section and the first portion has the same dimensions in at least one direction as the round cross section of the second portion. For example, the engaging element is formed by an open ring on the second closing body. Such a design makes it possible to forego a sleeve, which can reduce manufacturing costs.

In yet another advantageous embodiment, the device can, furthermore, contain a first stopper that is attached to the closing rod and that prevents the closing rod from being led out of at least one feedthrough in a first axial direction. In yet another advantageous embodiment, the device can contain a second stopper that is attached to the closing rod and that prevents the closing rod from being led out of at least one feedthrough in a second axial direction that is opposite the first axial direction. For example, the first stopper can have a spring element that allows the closing rod to be pulled against a spring force in the second direction, thus axially securing the closing rod. The spring force in the second direction makes it possible to further secure the closure device because the closing rod can be pulled into a locking position (e.g., a recess).

In yet another advantageous embodiment, the device can have a bar with which the rotating position of the closing rod in relation to the first closing body required for closure can be locked. For example, the bar is fixable in a recess in the first closing body.

In yet another advantageous embodiment, the first closing body can feature a surface design through which the bar can be independently guided via the spring force of the first stopper, thereby locking the closing rod. For example, the surface design can be an inclined plane. Thus, it is possible to achieve automatic locking and further reduce the risk of inadvertent opening.

In yet another advantageous embodiment, the opening angle (i.e., the angular range of the slit) of the open ring can be 5° or more. For example, the opening angle can also be smaller than 160°. In addition or alternatively, the diameter of the closing rod can be at least 0.5 mm, particularly at least 1 mm, more particularly at least 3 mm, and even more particularly 5 mm. An appropriate selection of the diameter of the closing rod makes it possible to achieve a compromise between load capacity and size.

### BRIEF DESCRIPTION OF THE DRAWINGS

Examples for carrying out the invention are shown in the figures and are described in more detail as follows:

FIG. 1A shows an exploded view of a closure device according to the embodiments of the present invention wherein an engaging element is formed by a sleeve and an open ring;

FIG. 1B shows the closure device of FIG. 1A, in assembled form and locked position;

FIG. 2A shows a further closure device according to the embodiments of the present invention wherein the closing rod is rotated via an engaging element;

FIG. 2B shows the closure device of FIG. 2A, in assembled form and locked position;

FIG. 3 shows a further closure device according to the embodiments of the present invention wherein an engaging element is formed by an open ring;

FIG. 4 shows a closure device according to embodiments of the present invention, in assembled form and locked position;

FIGS. 5A and 5B show sectional views of the closure device according to embodiments of the present invention; and

FIGS. 6A and 6B show sections of the closure device according to embodiments of the present invention wherein automatic locking and prevention of opening are ensured by the surface structure of the first closing body.

### DETAILED DESCRIPTION OF ILLUSTRATIVE EMBODIMENTS

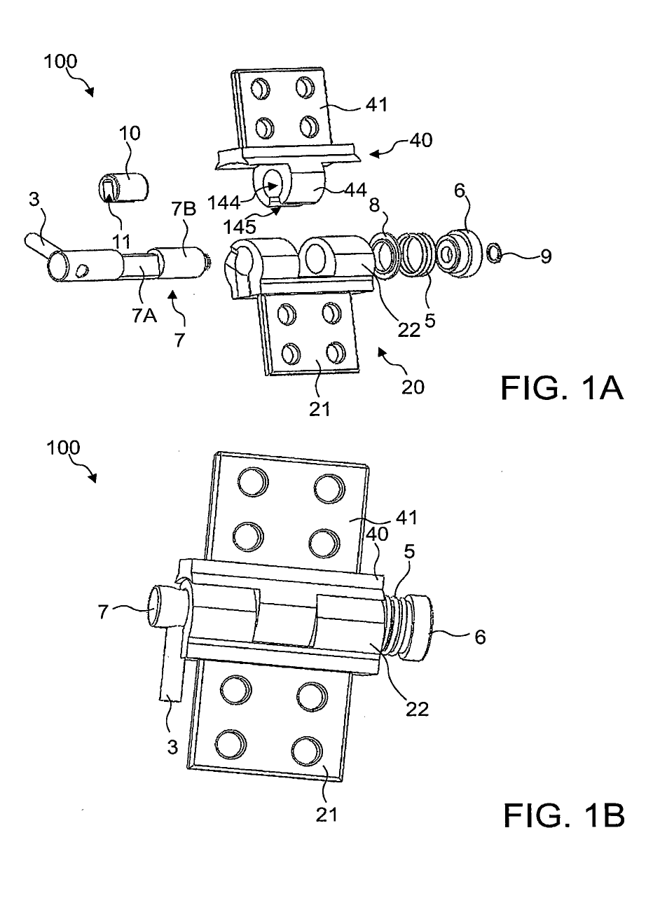

FIG. 1A shows a first embodiment of a closure device 100. The closure device 100 contains a first closing body 20 and a second closing body 40. The closing bodies each have one or more rings on a locking side of the closing body and a fastening element on a side opposite the locking side. The first closing body 20 has a first fastening element 21. The second closing body 40 has a second fastening element 41.

The purpose of the fastening elements is to secure the objects to be connected such as, for example, belts, bands, ropes, blinds, and lifting elements, as well as load elements such as chains, or other elements that are meant to be connected to each other in the closure device wherein the connection forms a lock that cannot be automatically opened. In FIG. 1A, the fastening elements are provided as plates with openings onto which the elements to be connected can, for example, be screwed.

The locking side of the first closing body 20 has at least one closed ring 22. The ring 22 or rings have an opening 122 into which a closing rod 7 can be guided. The embodiment shown in FIG. 1A contains two closed rings 22. The openings 122 and a cross section of a second portion 78 of the closing rod 7 are round. Thus, the closing rod 7 is rotatable in the opening 122 (i.e., a feedthrough) of the closed rings 22 of the first closing body. The hole or opening 122 is designed to positively integrate a sector of the closing rod 7.

FIG. 1B shows the closure device 100, in assembled form and locked position. The closing rod 7 is guided through the feedthroughs and openings 122 of the closed rings of the first closing body 20, respectively. The closing rod 7 is, for example, fastened to the first closing body 20 via a clamping ring 9 that can be inserted into a notch at the end of the closing rod. Typically, further elements such as, for example, a washer 8 or a thrust ring 6 can be used.

In typical embodiments, which can be combined with other embodiments, a spring 5 is further provided that pushes the closing rod 7 in an axial direction, for example, via the thrust ring 6 into a stop position. The stop position can be provided, for example, via the locking lever 3, which pushes against the end surface of the first closing body 20.

The second closing body 40 has at least one open ring 44. The open ring 44 comprises an opening 144 and a slit 145. The slit 145 forms the opening of the ring 44. The hole or opening 144 is designed to positively integrate a sleeve 10. According to some embodiments, a sleeve 10 can be introduced into the opening 144 or the feedthrough of the open ring 44. The sleeve can be axially mounted in the feedthrough, for example, by providing an at least partially circumferential notch (not shown) in the shell surface of the sleeve; a ring or balls arranged in the feedthrough can interfere with this sleeve. Other axial fasteners of the sleeve can also be equipped. For example, the axial sleeve size can be smaller than the size of the open ring 44. Here, a stop element 3a can be provided on the axial sides of the open ring.

Typically, the sleeve 10 has a cavity 11. This corresponds to the slit 145 and serves to incorporate a part of the closing rod 7. The part of the closing rod 7 that is introduced into the cavity 11 of the sleeve, for example through the slit 145, is at least a first portion 7A of the closing rod 7. The first portion 7A represents a tapering or a reduced expansion in at least one radial dimension of the closing rod 7.

In typical embodiments, which can be combined with other embodiments, the first portion 7A of the closing rod has an axial size that corresponds to the axial size of the open ring 44 of the opening 144 (the length of the open ring). That is to say, the axial expansion of the first portion 7A is the same as the length of the open ring or larger than the length of the open ring.

In typical embodiments, which can be combined with the embodiment described here, the closing rod, which in part has a round cross section in the second sections 7B, is flattened in the first portion 7A. For example, in the first portion 7A, the closing rod features two flat (or plane) surfaces or even four flat (or plane) surfaces.

To close the closure device 100, the first closing body 20 and the second closing body 40 are slid into one another. Here, the first portion 7A of the connecting rod 7 is fed through the slit 145 or the opening of the open ring 44 into the cavity 11 of the sleeve 10. By rotating the closing rod 7, the sleeve 10 rotates in the opening 144 of the open ring 44. Thereby, the cavity 11 and the opening of the cavity 11 rotate relative to the slit 145. The closure device 100 is closed.

In the embodiments described here, the open ring 44 has an undercut around the sleeve 10. As a result, the open ring 44 has a circumferential expanse of more than 180°. Thus, the sleeve 10 is fixed in radial direction in the opening 144 of the open ring. This contributes to the closing of the closure device 100.

In locked position (i.e., by suitably rotating the closing rod 7), the locking lever 3 can be pushed into a recess in the first closing body 20 via the spring 5. This can prevent any undesired rotation of the closing body 7.

In typical embodiments, which can be combined with other embodiments, the device can be locked by a rotation of at least 45°. Typically, the device is locked by a rotation of 90° or more, for example up to 315°. In preferred examples, the device is locked by a rotation of 180°, particularly 120° or 150°. In further typical embodiments, a closure device with a sleeve can be locked by a rotation about 120° or about 150°, and a closure device without a sleeve can be locked by a rotation of about 90° or about −90°.

The closure device 100 described in FIGS. 1A and 1B has two closed rings 22 and an open ring 44. These rings are arranged in such a way that when the closure device 100 is assembled, the rings are arranged at other axial positions of the closing rod 7 and can thus be interlocked. In further embodiments, which can be combined with other embodiments described here, at least one of the closing bodies has two rings and the other closing body has at least one ring. The closing bodies can, however, have several rings, such as, for example, three rings, four rings, five rings, or even more rings. Typically, the first closing body has one more ring than the second closing body, thereby ensuring easy assembly of the fastening rod to the first closing body. The number of rings is provided, among other things, by the axial expansion of the closure device. Thus, for large closure devices, a large number of rings (e.g., thirty rings or more) can be provided.

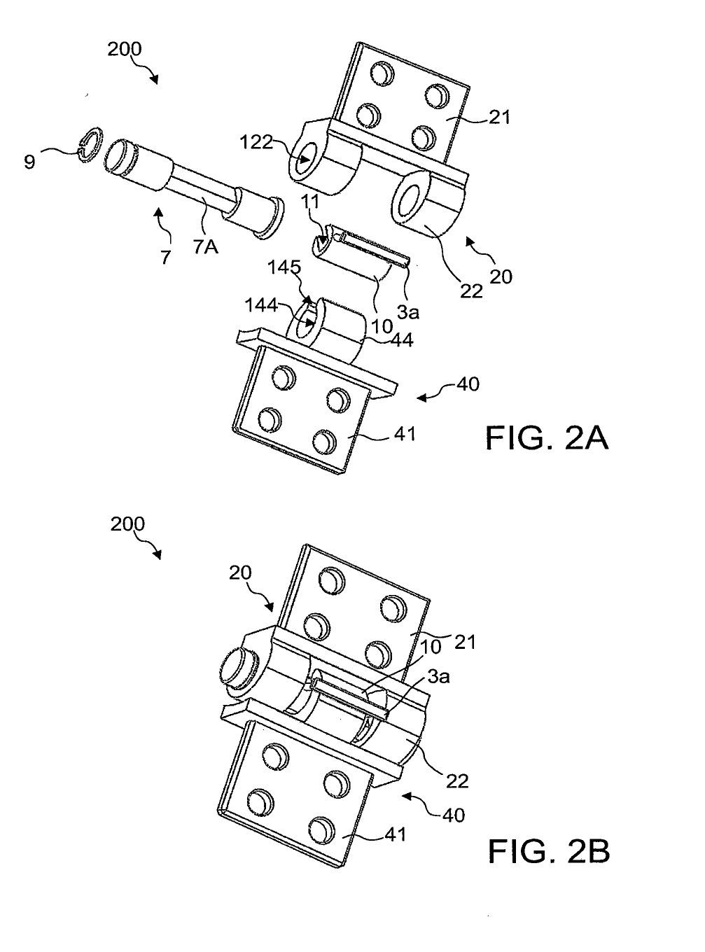

FIG. 2A shows a further embodiment of a closure device 200. This closure device 200 provides a locking lever 3A at the sleeve 10, as opposed to the locking lever 3 shown, for example, in FIG. 1A. With the locking lever 3A, the sleeve 10 can be rotated in the open ring 44; for example, after the closing rod 7 with the first section 7A is introduced into the cavity 11 of the sleeve 10. This allows a rotation of the cavity 11 or the opening of the cavity 11 relative to the slit 145 of the open ring. Thereby, the closure device 200 is locked.

The undercut of the open ring 44 locks the sleeve 10 radially in the open ring 44. After rotation of the cavity 11 relative to the slit 145, the rod and the first closing body 20, to which the closing rod 7 is fastened to the closed rings 22, can no longer be moved away from the second body, which leads to locking of the closure device 200.

In typical embodiments, which can be combined with other embodiments described here, the first portion 7A of the closing rod 7 features at least two opposing surfaces. These surfaces can be arranged, for example, parallel to each other. These surfaces are spaced to allow the first portion 7A of the closing rod 7 to be fed into cavity 11 of sleeve 10. Furthermore, it is possible to provide a chamfer on the surfaces of the first portion 7A and/or to provide a sector with less spacing between the surfaces in order to more easily feed the closing rod 7 into the cavity 11 of the sleeve.

Because the embodiment shown in FIG. 2A makes it possible to lock the closure device 200 by rotating the sleeve 10, it is not necessary to adjust the closing rod 7, for example at a recess in the first closing body 20. The closing rod 7 is arranged in the closed rings 22 and the openings 122 so as to allow the closing rod 7 to rotate. A fastener of the closing rod 7, which contains a spring as shown in FIG. 1, can be reduced to an axial fastener with only one spring ring in FIG. 2A. In other embodiments, adjustment of the closing rod 7 in the closing body 20 can also be carried out for embodiments such as the ones described with respect to FIG. 2A. Other axial fasteners of the closing rod can also be provided by screws or other means. Such means serve the axial fastening of the rod to prevent the rod from slipping out of the openings 122 (i.e., the feedthroughs) through the rings in an axial direction.

FIG. 2B shows the closure device 200 in a locked position. The first closing body 20 and the second closing body 40 are positioned into one another, wherein the first portion 7A of the closing rod 7 is fed into the slit 145 of the open ring 44. Rotating the locking lever 3A rotates the cavity 11 in the sleeve 10 opposite the slit 145 of the open ring 44, which in turn rotates the closing rod 7. In this condition, the closing rod 7 is radially fastened in the open ring 44, thus locking the closure device 200.

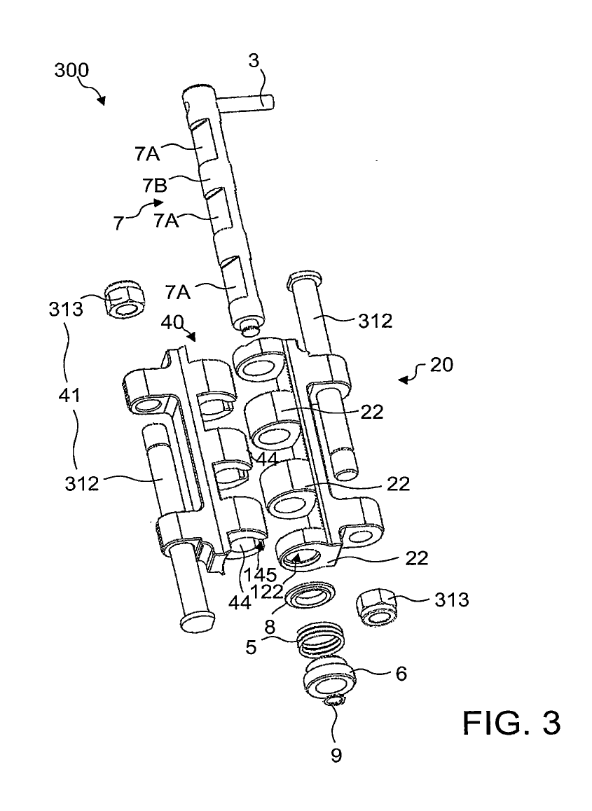

FIG. 3 shows a closure device 300 and serves as an illustration of further embodiments of the invention. Unlike the embodiments described, for example, with respect to FIGS. 1A and 1B, the first closing body 20 in FIG. 3 has, as an example, four rings and the second closing body 40 has, as an example, three rings. They are arranged in the axial direction of the closing rod 7 in such a way that they, according to the typical embodiments described here, can be alternatingly provided in the axial direction.

Analogous to the embodiments already described with respect to FIGS. 1A and 1B, a locking lever 3 is attached to the closing rod 7, wherein the closing rod 7 is attached to the first closing body 20 via spring ring 9, thrust ring 6, spring 5, and washer 8.

In typical embodiments, which can be combined with other embodiments, the first fastener and the second fastener 41 can be provided, as shown in FIG. 3, via a bolt 312 and a fastening of the bolt 312 with a notch 313. As an example, the first fastener 41 is designated with a reference number in FIG. 3. Elements to be connected, such as belts, bands, ropes, chains, etc., can be fastened to the bolt 312. The bolt can be fastened to the respective closing body before or after via the notch 313.

A further difference to the embodiments described above is that the closure device 300 is formed without a sleeve. The first portions 7A are provided in such a way that both a cavity, for example in the form of two surfaces, and radial sectors exist in which the round contour of the closing rod 7 can be maintained. Thus, the first portions 7A of the closing rod 7 shown in FIG. 3 feature two sectors that extend in radial direction. First, the first sectors exist that are smaller than a round cross section. These sectors can be designed, for example, by two surfaces. Furthermore, second sectors exist in which circular sections are maintained. The size of these circular sections is equal to the open ring 44 or the opening 144 (i.e., the feedthrough) in the opening ring. This ensures the fastening of the closing rod 7 in the open ring after rotation of the closing rod 7, for example, by 90°.

In typical embodiments, which can be combined with other embodiments, one or more first portions 7A of a closing rod 7 can be designed in such a way that the size of the outer contour 7B, which has a round cross section, is the same in at least one direction as the size of the first portion 7A in this direction. In such a design, a sleeve can be omitted.

In other embodiments, which can also be combined with other designs, the cross section of the first portion 7A of the closing rod 7 is smaller than the round cross section in each direction. This creates the required space in the feedthrough of the open ring in order to use a sleeve for the closure device. The advantage of using such a sleeve is that the entire inner space of the opening 144 can be filled with a solid body or material (i.e., it is positive). For this purpose, the sleeve has, for example, a round outer contour that corresponds to the opening 144 of the open ring, and the cavity 11 in the sleeve can be designed to correspond to the size of the first portion 7A. Thus, with respect to the respective dimensions of the elements, the gap inside the round opening 144 of the open ring 44 is either very little or nonexistent.

In an embodiment without a sleeve, such as the one shown in FIG. 3, the cavities (i.e., the sectors with a reduced size) inside the first portion of the closing rod 7 are not directly adjacent to the solid body even after assembly in one of the open rings 44. An air gap is created between the cavity and a sector of the open ring. Not using a sleeve can, however, save costs; this is advantageous for some designs and applications.

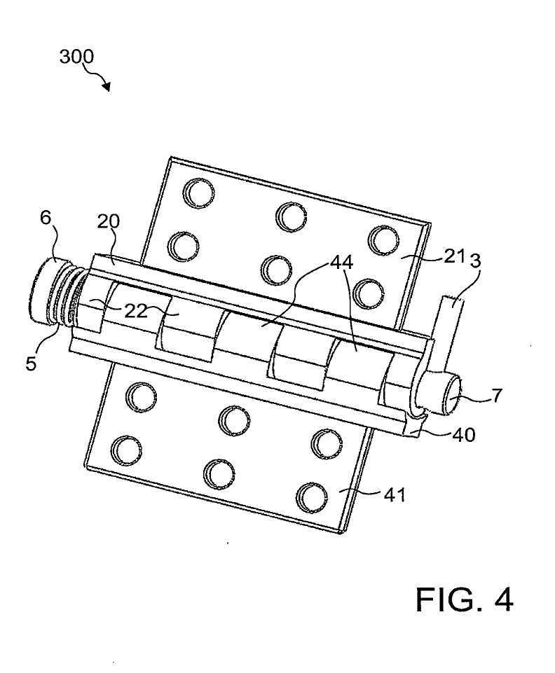

FIG. 4 shows the closure device 300 in an assembled and locked position. The locking lever 3 mounted to the closing rod 7 is in a locked position and is pushed by the spring 5 and the thrust ring 6 against the first closing body 20. The first closing body 20 has closed rings 22 and a fastener 21, on which one of the corresponding elements to be connected can be fastened. The second closing body 40 has open rings 44 and a fastener 41, on which one corresponding element to be connected can be fastened. In a locked position, the closing rod 7 is rotated to prevent the first portions 7A of the closing rod 7 from being fed through the slit in the open ring so that the closure remains in a locked position.

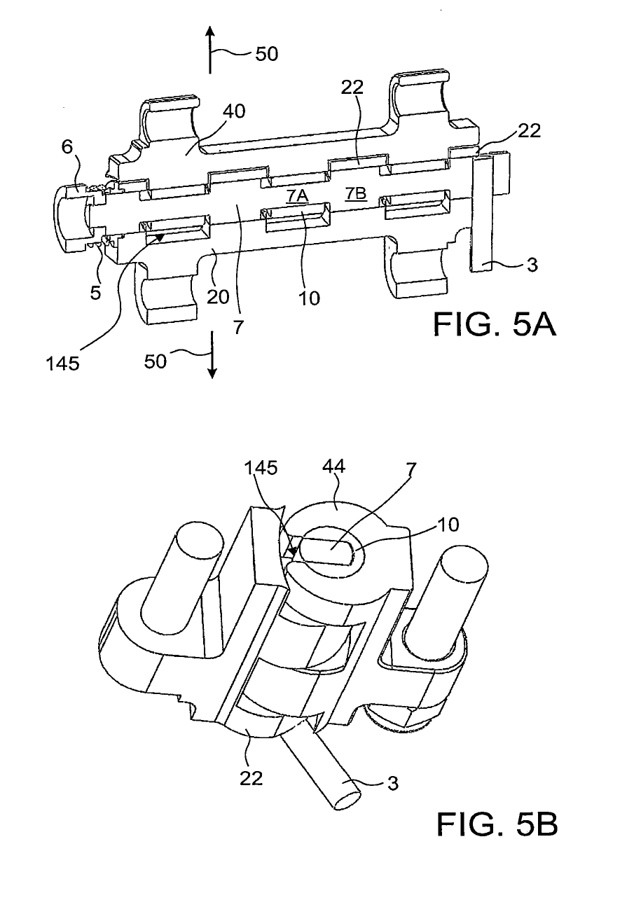

FIGS. 5A and 5B show two cross-sectional views of a closure device, wherein the functions of the closure device can be illustrated one more time in an embodiment of the present invention. FIG. 5A shows a closure device in a locked position. The first closing body 20, which is equipped with closed rings 22, is connected to the closing rod 7 in such a way that the closing rod 7 in the first closing body 20 can rotate. The portions 7B of the closing rod 7, which have a round cross section, rotate in the closed rings 22. The second closing body 40 has open rings; FIG. 5A exemplarily shows a slit 145. In FIG. 5A, the closing rod 7, which is rotated, for example, via a locking lever 3, is shown in such a way that the sleeve 10 or the sleeves 10 are rotated relative to the slit 145. Thus, the undercuts of the open rings encompass the sleeve. The sleeve is radially mounted, and the closing rod 7 and first closing body 20 cannot be moved in the direction of the arrows 50.

The device is opened, as shown in FIG. 5B (e.g., via the locking lever 3), by rotating the closing rod 7 in such a way that the cavity of the sleeve, and the opening of the cavity, is exposed in the direction of the slit 145 (i.e., the opening of the open ring 44). In this position the closing rod 7 can be guided out of the open ring, thereby opening the closure device. The closure device is closed by guiding the closing rod 7 through the opening of the open ring (i.e., through the slit 145 in the position shown in FIG. 5B). From the state shown in FIG. 5B, the closing rod 7, including the sleeve 10, can be rotated relative to the opening of the open ring (i.e., the slit) by rotating the closing rod 7 (e.g., via the locking lever 3), thereby locking the closure device.

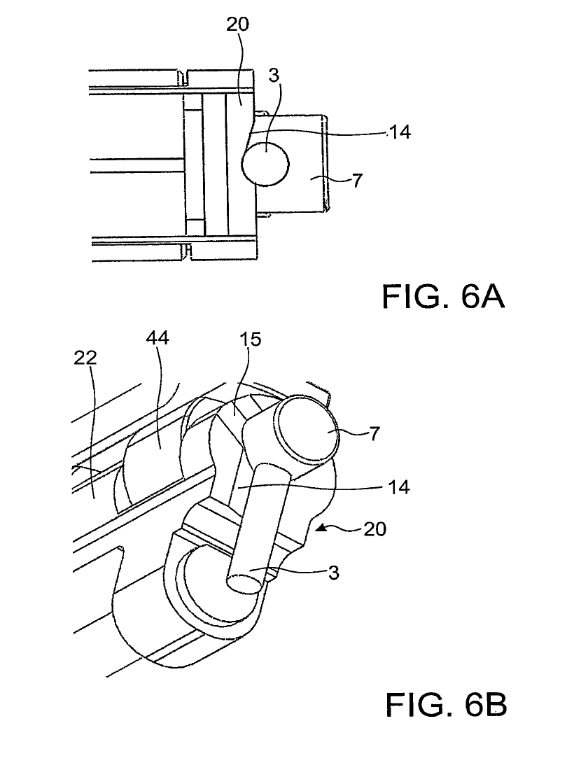

As shown in FIGS. 6A and 6B, the closure device can be designed to reduce the risk of automatic locking and/or undesired release. For this purpose, the first closing body 20 can be provided with an inclined plane 14. An inclined plane 15 can, additionally or alternatively, also be used for an open position. This forms a recess in the first closing body 20. Through the spring force of a spring 5, as shown, for example, in FIG. 1A, the locking lever 3 is pulled into the recess of the first closing body 20. Through the design of the inclined plane, this can occur automatically via the spring 5. In FIG. 6A, the closure device and the locking lever 3 are shown in a closed position. In FIG. 6B, the closure device and the locking lever 3 are shown in a closed position. Based on the spring force, the locking lever 3 can be guided from the open position along the inclined plane to a resting position.

In typical embodiments, the closure device can be closed by rotating the rod by at least 45° (e.g., up to 315°). Typically, the closing rod can be rotated by 90°, 120°, 150°, or 180° from an open position to a closed position.

In one possible embodiment, the closure device of the present invention is designed as a quick-release lock, for example, for lifting straps of different sizes, strength, and load capacity. The lifting straps can be made of polyester. For assembly, the quick-release lock can be easily coupled or uncoupled with lifting straps or other elements by tilting the middle rod, for example, by 120° .

The practical nature of the embodiments of the present invention (i.e., of the closure device and quick-release lock) compared to the conventional systems currently known in the art is fast and easy coupling and uncoupling, while maintaining safety standards during coupling and uncoupling. Compared to systems currently known in the art, springs do not have to be pushed together, and there is no need to lift belts/straps (e.g., to strap them into hooks). Furthermore, it is not necessary to introduce or extract bolts (e.g., in doors and other construction elements fastened by bolts).

In typical embodiments, which can be combined with the embodiments described here, the fastening width (i.e., the width of connection along the closing rod) can correspond to at least the width of the lifting strap or the elements to be combined. The belts or straps (e.g., polyester belts) can have different sizes, from 20 mm to 300 mm. Other custom sizes/formats can also be taken into account. Possible application examples for embodiments can include load lifting and the assembly of tents and large-scale tents, borders or fences (streets, squares, construction sites, etc.), anti-hail nets, sun shades, sails, etc. Other elements such as window shutters, doors, or those elements in which two components need to be quickly and detachably connected and securely coupled, can also be connected using the embodiments described here.

The quick-release lock can be made from different materials such as steel, light alloys, aluminum, plastic, etc. due to the required load capacity of, for example, 100 g or more, in particular 1 kg to 180 t, and more.

In further embodiments, which can be combined with the embodiments described here, the axial length of the closing rod can be at least 5 mm and is typically from 20 mm 500 mm. In addition, the diameter of the closing rod can, additionally or alternatively, be 0.5 mm or more, 3 mm or more, or, for example, 5 mm to 300 mm. In still further embodiments, which can be combined with the embodiments described here, the slit 145 and the opening of the open ring 44 can comprise an angular range of 5° or more or, for example, 10° 15°.

1-16. (canceled)

17. A closure device comprising:
a closing rod;
a first closing body, wherein the first closing body comprises at least one first feedthrough for the closing rod;
at least one engaging element; and
a second closing body, wherein the second closing body comprises at least one open feedthrough for the at least one engaging element,
wherein the closing rod is configured to be rotatably located in the at least one feedthrough and the at least one engaging element, and
wherein the first closing body and the second closing body are repeatedly connectable and disconnectable.

18. The closure device according to claim 17, wherein the closing rod is rotatable from a first rotational position to a second rotational position, wherein the first rotational position is an open position and the second rotational position is a closed position, and wherein the closing rod is axial movable to rotated from the first rotational position to the second rotational position.

19. The closure device according to claim 17, wherein the at least one engaging element is located in the at least one open feedthrough of the second closing body in a rotatable manner.

20. The closure device according to claim 17, wherein the at least one engaging element is configured to laterally encompass a first portion of the closing rod and is configured to be rotated by rotating the closing rod.

21. The closure device according to 17, wherein the at least one engaging element comprises a cylindrical body that features a lateral cavity configured to receive a portion of the closing rod.

22. The closure device according to claim 21, wherein the at least one engaging element further comprises a locking lever.

23. The closure device according to claim 17, wherein the closing rod comprises at least a first portion and at least a second portion, wherein the second portion has a round cross section, and wherein a cross section of the first portion is smaller than the round cross section of the second portion.

24. The closure device according to claim 17, wherein the closing rod comprises at least a first portion and at least a second portion, wherein the second portion has a round cross section, and wherein a cross section of the first portion has the same size in at least one direction as the round cross section of the second portion.

25. The closure device according to claim 24, wherein the at least one engaging element comprises at least a sleeve configured to fit into an open ring of the at least one open feedthrough.

26. The closure device according to claim 17, further comprising a first stopper mounted to the closing rod, wherein the first stopper prevents the closing rod from moving out of the at least one feedthrough in a first axial direction.

27. The closure device according to claim 26, comprising a second stopper mounted to the closing rod, wherein the second stopper prevents the closing rod from moving out of the at least one feedthrough in a second axial direction that is opposite the first axial direction.

28. The closure device according to claim 26, wherein the first stopper comprises a spring element that allows the closing rod to be pulled or pushed via a spring force into a second direction.

29. The closure device according to claim 17, wherein the closing rod comprises a locking device with which the closing rod is rotatable with respect to the first closing body from a first rotational position to a second rotational position.

30. The closure device according to claim 29, wherein the locking device comprises a locking lever.

31. The closure device according to claim 30, wherein the locking lever is fixable in a recess of the first closing body.

32. The closure device according to claim 29, wherein the first closing body comprises a surface design such that when the closing rod is turned via the locking device the closure device is lockable by locking the locking device in the surface design.

33. The closure device according to claim 17, wherein a diameter of the closing rod is at least 0.5 mm.

34. A closure device comprising:
a closing rod comprising at least one first portion and a at least one second portion;
a first closing body, wherein the first closing body comprises at least one first feedthrough, and wherein the at least one first portion of the closing rod is rotatably mounted in the at least one first feedthrough;
at least one engaging element; and
a second closing body, wherein the second closing body comprises at least one open feedthrough, and wherein the at least one engaging element is rotatably mounted in the at least one open feedthrough,
wherein the first closing body is connectable to the second closing body by locating the at least one second portion in the at least one engaging element,
wherein the first closing body is lockable to the second closing body by rotating the closing rod from an open position to a closed position, and
wherein the first closing body and the second closing body are repeatedly connectable and disconnectable.

35. The closure device according to claim 34, wherein the first closing body has two first feedthroughs and the second closing body has one open feedthrough.

36. The closure device according to claim 34, wherein the first closing body has four first feedthroughs and the second closing body has three open feedthroughs.
